(19) United States
(12) Patent Application Publication
(10) Pub. No.: US 2023/0027218 A1
(43) Pub. Date: Jan. 26, 2023

(54) Display Screen and Terminal

(71) Applicant: CHONGQING KONKA PHOTOELECTRIC TECHNOLOGY RESEARCH INSTITUTE CO., LTD., Chongqing (CN)

(72) Inventors: Xiaolin LIANG, Chongqing (CN); YING-CHI WANG, Chongqing (CN)

(21) Appl. No.: 17/866,592

(22) Filed: Jul. 18, 2022

Related U.S. Application Data
(63) Continuation of application No. PCT/CN2021/107303, filed on Jul. 20, 2021.

(51) Int. Cl. G09G 3/32; H04N 5/232

(52) U.S. Cl. CPC G09G 3/32; H04N 5/23293

(57) ABSTRACT

The present application relates to a display screen and a terminal. The display screen not only includes a light-emitting diode (LED) pixel units and a display driving circuit for driving the LED pixel units for display, but also includes light filtering units, light sensing units and a light sensing input circuit for transmitting a light sensing result of the light sensing units. In this way, the display screen can use the light sensing units to inductively convert light passing through the light filtering units into an electrical signal so as to collect an image, and further to achieve an effect of integrating an image display function and an image collection function. When the display screen is provided for a terminal, no separate camera module for image photographing needs to be arranged under the screen, such that a thickness and cost of the terminal can be greatly reduced, and portability and product competitiveness of the terminal can be improved.

### TECHNICAL FIELD

The present application relates to the technical field of electronics, in particular to a display screen and a terminal.

### BACKGROUND

In order to arrange a camera module on terminal apparatuses such as a mobile phone and a PAD to collect images, it is usually necessary to make a hole on a display screen to obtain an adequate viewing window for the camera module, which obviously will affect the display effect of the display screen to a great extent. Since the camera module is thick, it will still limit reduction in the thickness of the terminal, affect improvement of the portability of the terminal and thus restrict the product competitiveness of the terminal even if it's arranged under the display screen to collect images.

Therefore, how to reduce the thickness of the terminal is a problem to be solved urgently.

### SUMMARY

In view of the defects of the related technology, the present application aims to provide a display screen and a terminal, so as to solve the problems that the thickness of the terminal may not be reduced and the portability is poor since a camera module needs to be independently arranged in the terminal.

A display screen includes:

a bearing substrate;

a transparent light filtering configuration substrate;

a display layer including a plurality of light-emitting diode (LED) pixel units, the LED pixel units being configured to convert an electrical signal into an optical signal;

a light sensing layer including a plurality of light sensing units, the light sensing units being configured to convert an optical signal into an electrical signal; and

a light filtering layer including a plurality of light filtering units;

wherein the light filtering units are arranged on the light filtering configuration substrate, and the LED pixel units and the light sensing units are all arranged on the bearing substrate and electrically connected to a display driving circuit on the bearing substrate and a light sensing input circuit on the bearing substrate respectively; light incident surfaces of the light sensing units and light emergent surfaces of the LED pixel units face a same direction, and the light incident surfaces of the light sensing units face the light filtering units; and the light sensing units are located in spaces between the adjacent LED pixel units and correspond to the light filtering units in position.

The display screen not only includes the LED pixel units and the display driving circuit for driving the LED pixel unit for display, but also includes the light filtering units, the light sensing units and the light sensing input circuit for transmitting a light sensing result of the light sensing units. In this way the display screen may use the light sensing units to inductively convert light passing through the light filtering unit into an electrical signal so as to collect an image, and further to achieve an effect of integrating an image display function and an image collection function. When the display screen is provided in a terminal, no separate camera module for image photographing needs to be arranged under the screen, such that thickness and cost of the terminal may be greatly reduced, and portability and product competitiveness of the terminal may be improved.

Optionally, the display screen further includes a display driving chip and a light sensing processing chip, where the display driving chip is configured to receive a control signal from a main control chip and control, via the display driving circuit according to the control signal, the LED pixel units to work; and the light sensing processing chip is configured to receive, via the light sensing input circuit, an electrical signal converted by the light sensing units and convert the electrical signal into image data.

Optionally, the display screen further includes a one-way anti-reflection film arranged on one side, away from the light sensing units, of the light filtering units.

In the display screen, a one-way anti-reflection film is further arranged on one side, away from the light sensing layer, of the light filtering units, that is, the one-way anti-reflection film is arranged on a light incident surface of the light filtering units and the one-way anti-reflection film may prevent light of the light filtering units from escaping to the outside, such that the light filtering units are “invisible” in vision, an image collection effect is improved, and visual pollution caused by the light filtering units is further avoided, so as to enhance a display effect of the display screen.

Optionally, the display layer and the light sensing layer are located on a same horizontal plane.

In the display screen, the display layer and the light sensing layer are located on the same horizontal plane, so as to reduce a total thickness of the display layer and the light sensing layer, and further to reduce a thickness of the display screen.

Optionally, the display screen further includes a first retaining wall arranged along an edge of the bearing substrate and enclosing the display layer and the light sensing layer.

In the display screen, the first retaining wall is arranged around the LED pixel units and the light sensing units, so as to prevent external light from entering the LED pixel units and the light sensing units, an influence of the external light on the display effect of the display screen is avoided, and an influence of the external light on the image collection effect of the light sensing units is also avoided.

Optionally, the light filtering layer further includes a transparent adhesive layer which is opposite to the LED pixel unit in the display layer in position.

In the display screen, a transparent adhesive layer is arranged at a position, corresponding to the LED pixel units, in the light filtering layer, the transparent adhesive layer does not influence light emitting of the LED pixel units and may protect the LED pixel units, and a barrier may be formed by the transparent adhesive layer and the light filtering layer to block external water vapor and tiny dust, so as to improve reliability of the LED pixel units and the light sensing units.

Optionally, the display screen further includes a second retaining wall arranged along an edge of the light filtering configuration substrate and enclosing the light filtering layer.

Optionally, the display screen includes a first area and a second area, where the light sensing units and the light filtering units are distributed in the first area merely; and in the second area, a light blocking unit is arranged in a space between adjacent LED pixel units.

Optionally, the light sensing units are uniformly distributed in all areas of the display screen.

Based on the same inventive concept, the present application further provides a terminal. The terminal includes a main control chip and the display screen, and the display driving circuit and the light sensing input circuit in the display screen are in communication connection with the main control chip separately, and the main control chip is configured to control the LED pixel units via the display driving circuit for display, and is configured to obtain an image collection result of the light sensing units via the light sensing input circuit.

The display screen of the terminal not only includes LED pixel units and the display driving circuit for driving the LED pixel units for display, but also includes light filtering units, light sensing units and the light sensing input circuit for transmitting a light sensing result of the light sensing units. In this way, the display screen may use the light sensing units to inductively convert light passing through the light filtering units into an electrical signal so as to collect an image, and further to achieve an effect of integrating an image display function and an image collection function. Therefore, in a terminal, no separate camera module needs to be arranged under the screen for image collection, such that thickness and cost of the terminal may be greatly reduced, and portability and product competitiveness of the terminal may be improved.

### BRIEF DESCRIPTION OF THE DRAWINGS

FIG. 1 is a schematic diagram of an arrangement position of a display screen and a camera module in the related art in the present application;

FIG. 2 is a schematic diagram of a sectional structure of a first display screen provided in an optional embodiment of the present application;

FIG. 3 is a structural schematic diagram of a light filtering unit set provided in an optional embodiment of the present application;

FIG. 4 is a schematic diagram of a sectional structure of a second display screen provided in an optional embodiment of the present application;

FIG. 5 is a schematic diagram illustrating a division of a photographing area and a non-photographing area on a display screen in an optional embodiment of the present application;

FIG. 6 is a schematic diagram of a sectional structure of a third display screen provided in an optional embodiment of the present application;

FIG. 7 is a schematic diagram of a sectional structure of a fourth display screen provided in an optional embodiment of the present application;

FIG. 8 is a schematic diagram of a sectional structure of a fifth display screen provided in an optional embodiment of the present application;

FIG. 9 is a structural schematic diagram of hardware of a terminal provided in an optional embodiment of the present application;

FIG. 10 is a schematic diagram of a sectional structure of a display screen provided in another optional embodiment of the present application;

FIG. 11 is a schematic diagram of a circuit structure in a display screen provided in another optional embodiment of the present application; and

FIG. 12 is a schematic diagram illustrating obtaining of a voltage value of light sensing units by a light sensing processing chip provided in another optional embodiment of the present application.

### BRIEF DESCRIPTION OF THE REFERENCE NUMBERS

101—camera module; 102—display screen; 1021—light-transmitting area; 1022—non-light-transmitting area; 20—display screen; 201—first area; 202—second area; 21—bearing substrate; 211—display bearing substrate; 212—light sensing bearing substrate; 22—light filtering configuration substrate; 23—display layer; 230—LED pixel unit; 24—light sensing layer; 240—light sensing unit; 25—light filtering layer; 250—light filtering unit; 251—transparent adhesive layer; 2501—red light filtering unit; 2502—blue light filtering unit; 2503—green light filtering unit; 2504—one-way anti-reflection film; 260—light blocking unit; 271—first retaining wall; 272—second retaining wall; 40—display screen; 60—display screen; 70—display screen; 9—terminal; 91—main control chip; 92—display screen; 921—display driving circuit; 922—light sensing input circuit; 931—display driving chip; 932—light sensing processing chip; 100—display screen; 111—bearing substrate; 112—light filtering configuration substrate; 121—LED pixel unit; 122—light sensing unit; 123—light filtering unit; 1230—one-way anti-reflection film; 124—transparent layer; 131—first retaining wall; 132—second retaining wall; 141—display driving chip; and 142—light sensing processing chip.

### DETAILED DESCRIPTION OF THE EMBODIMENTS

To facilitate an understanding of the present application, the present application will be described more fully hereinafter with reference to the associated drawings. A preferred embodiment of the present application is given in the drawings. However, the present application may be implemented in many different forms and is not limited to the embodiments described herein. Rather, these embodiments are provided so as to understand the disclosed content of present application more thoroughly and completely.

Unless defined otherwise, all technical and scientific terms used herein have the same meaning as commonly understood by those skilled in the art to which the present application belongs. The terms used in the specification of the present application herein are for the purpose of describing specific embodiments merely and is not intended to be limiting of the present application.

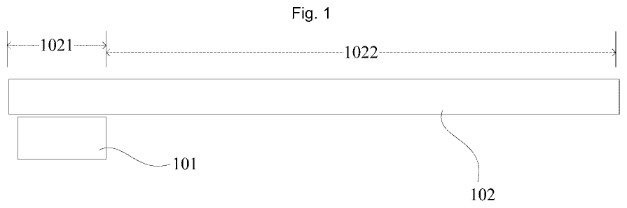

Since under-screen photographing may guarantee completeness of a display screen and improve the display effect, under-screen photographing becomes a mainstream photographing technology of terminal products, for example, mobile phones at present. However, current under-screen photographing also has significant drawbacks. For example, with reference to FIG. 1, a camera module 101 is arranged below a display screen 102, the display screen 102 is divided into a light-transmitting area 1021 and a non-light-transmitting area 1022, and the light-transmitting area 1021 corresponds to the camera module 101 in position. In this way, when the camera module 101 needs to collect an image, light incident on the screen from the outside may be collected via the light-transmitting area 1021, such that an optical signal is converted into an electrical signal, and then the electrical signal is converted into a digital signal, so as to collect the image.

Limited by an existing camera technology, a size and thickness of the camera module 101 are usually large, such that a size and thickness of a terminal may not be reduced to a state expected by a user, which hinders the development trend of lightness, thinness and portability of a terminal product.

On the basis of this, the present application desires to provide a solution to the above technical problem, the details of which will be set forth in the following embodiments.

An optional embodiment of the present application:

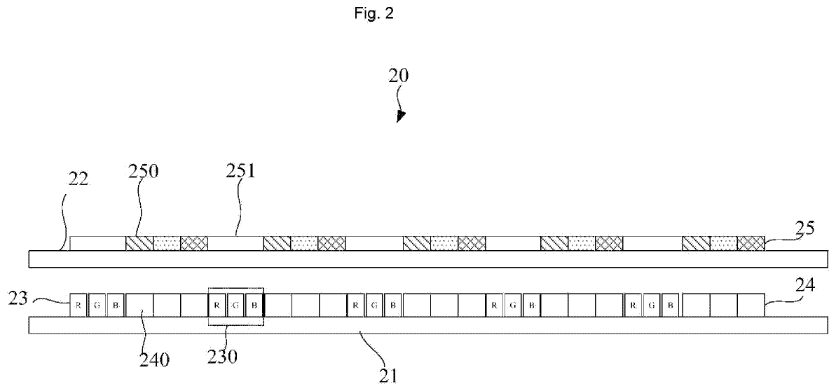

The embodiment provides a display screen. With reference to FIG. 2 showing a schematic diagram of a sectional structure of the display screen, the display screen 20 includes a bearing substrate 21, a light filtering configuration substrate 22, a display layer 23, a light sensing layer 24 and a light filtering layer 25.

The display layer 23 includes a plurality of light-emitting diode (LED) pixel units 230, and each of the LED pixel units 230 may include one or more LED chips capable of converting an electrical signal into an optical signal. As for a color display screen, the LED pixel units 230 at least include RGB three primary colors of LED chips. In some other examples of this embodiment, the LED pixel units 230 may further include, in addition to red, green, and blue LED chips, LED chips capable of emitting light of other colors, for example, LED chips capable of emitting indigo light, LED chips capable of emitting yellow light, etc. The LED pixel units 230 are arranged on the bearing substrate 21, are electrically connected to a display driving circuit (not shown in FIG. 2) on the bearing substrate 21, and may operate under driving by the display driving circuit. Via different control over the LED pixel units 230 in the whole display screen 20, display of the display screen 20 may be achieved. Notably, the display driving circuit is arranged on the bearing substrate 21, and “on” does not mean that the display driving circuit is necessarily located on a surface of the bearing substrate 21, nor does it mean that the display driving circuit is located on an upper portion of the bearing substrate 21. As long as the display driving circuit makes contact with the bearing substrate 21, it may be considered that the display driving circuit is arranged on the carrier substrate 21, so in some examples, the display driving circuit may be arranged on a surface of the bearing substrate 21, and in other examples, the display driving circuit may be arranged inside the bearing substrate 21.

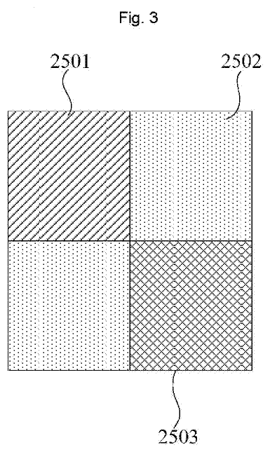

The light filtering layer 25 includes a plurality of light filtering units 250 arranged on the light filtering configuration substrate 22, the light filtering units 250 allow some light to pass while preventing other light from reaching the other layer from one side, and in brief, the light filtering units 250 are optical devices that may be used to select a desired wavelength band of radiation. In this embodiment, the light filtering layer 25 includes a light filtering unit set, and the light filtering unit set is formed by a plurality of light filtering units 250 of different colors. For example, with reference to FIG. 3 showing a structural schematic diagram of a light filtering unit set, the light filtering unit set may include a red light filtering unit 2501 merely transmitting red light, a blue light filtering unit 2502 merely transmitting blue light, and a green light filtering unit 2503 merely transmitting green light. In some examples of this embodiment, ratios of the red, green and blue light filtering units in one light filtering unit set are substantially identical, but in some other examples of this embodiment, the ratios of the red and blue filter light filtering units in one light filtering unit set are 25% respectively, and the ratio of the green light filtering units is 50%, so as to form a red, green, blue and green (RGBG) light filtering unit set, and the RGBG light filtering unit set is a primary color filter, also referred to as a Bayer filter. It is understandable that the ratio of each color of light filtering units in the light filtering unit set may also be another value, which is not repeated herein. In some other examples of this embodiment, the light filtering unit set may further include other colors of light filtering units in addition to red, green and blue light filtering units, and the configuration of the other colors of light filtering units may achieve color complement, such that the light filtering unit set including the light filtering units with colors other than red, green and blue is actually a complementary color filter. For example, in one example of this embodiment, the light filtering unit set further includes a yellow light filtering unit, and the red, green, blue, and yellow light filtering units each account for 25%, thereby forming an RGBY light filtering unit set. Typically, the light filtering units in the light filtering layer 25 are arranged directly in a form of a light filtering unit set, that is, the light filtering units belonging to one light filtering unit set are arranged adjacent to one another. In some examples, the light filtering units 250 also need to be driven by an electrical current to operate. For example, the light filtering units 250 are electrochromic light filtering element or liquid crystal light filtering element. In these examples, a light filtering driving circuit for driving the light filtering units 250 may be arranged on the light filtering configuration substrate 22.

The light sensing layer 24 includes a plurality of light sensing units 240 arranged on the bearing substrate 21, and the light sensing units 240 may be configured to convert an optical signal into an electrical signal. The light sensing units 240 are electrically connected to a light sensing input circuit (not shown in FIG. 2) on the bearing substrate 21 to transmit a photoelectric conversion result of the light sensing units to the light sensing processing chip via the light sensing input circuit. Similarly, the light sensing input circuit may be arranged on a surface of the bearing substrate 21, or may be arranged inside the bearing substrate 21.

In this embodiment, light incident surfaces of the light sensing units 240 and light emergent surfaces of the LED pixel units 230 face a same direction, such that the light sensing units 240 sense an optical signal in which direction the display layer 23 displays an image. Moreover, the light incident surfaces of the light sensing units 240 face the light filtering units 250, and the light sensing units 240 in the light sensing layer 24 correspond to the light filtering units 250 in the light filtering layer 25 in position, such that the light incident surfaces of the light sensing units 240 are opposite light emergent surfaces of the light filtering units 250. In this way, light passing through the light filtering units 250 may be sensed by the light sensing units 240 to generate an electrical signal. Moreover, since the light sensing units 240 are arranged in a space between adjacent LED pixel units 230, the light sensing units 240 and the light filtering units 250 do not influence light emergence of the LED pixel units 230, and do not influence a display effect of the display layer 23.

Since the light filtering layer 25 is located on the light incident surface of the light sensing layer 24, the light filtering layer 25 is also located on a light emergent surface of the display layer 23. In this case, the light filtering configuration substrate 22 for bearing the light filtering layer 25 is necessarily also located on the light emergent surface of the display layer 23. In order to prevent the light filtering configuration substrate 22 from influencing display of the display layer 23, in this embodiment, the light filtering configuration substrate 22 is transparent, for example, the light filtering configuration substrate 22 may be a glass substrate. In some examples of this embodiment, the light filtering configuration substrate 22 may also be a sapphire substrate, etc.

It is understandable that in FIG. 2, although the light filtering configuration substrate 22 is closer to the light sensing layer 24 than the light filtering layer 25, that is, the light filtering configuration substrate 22 is arranged between the light filtering units 250 and the light sensing units 240, in some other examples of this embodiment, the light filtering configuration substrate 22 may also be located on one side, away from the light sensing layer 24, of the light filtering layer 25. In an orientation in which the light sensing layer 24 is lower than the light filtering layer 25 is upper, the light filtering configuration substrate 22 may be arranged below the light filtering layer 25, or the light filtering configuration substrate 22 may be arranged above the light filtering layer 25.

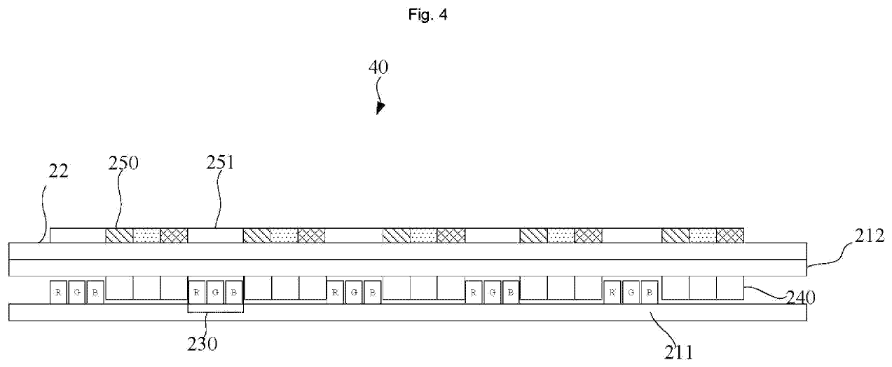

It is understandable that although the bearing substrate 21 in the display screen 20 in FIG. 2 consists of only one substrate, the display driving circuit and the light sensing input circuit are arranged on one substrate, such that the LED pixel units 230 and the light sensing units 240 are also arranged on a same bearing substrate 21, and the display layer 23 and the light sensing layer 24 are located on one horizontal plane. However, in some other examples of this embodiment, the bearing substrate 21 in the display screen may include two or even more substrates, and the light sensing layer 24 and the display layer 23 are located on different substrates. For example, in an example of this embodiment, with reference to a display screen 40 in FIG. 4, the bearing substrate 21 includes a display bearing substrate 211 and a light sensing bearing substrate 212, where a display driving circuit is arranged on the display bearing substrate 211, such that a display layer 23 is located on the display bearing substrate 211; and a light sensing input circuit is arranged on the light sensing bearing substrate 212, such that a light sensing layer is located on the light sensing bearing substrate 212.

In FIG. 4, the light sensing bearing substrate 212 is located between the display bearing substrate 211 and the light filtering configuration substrate 22, such that in order to prevent the light sensing bearing substrate 212 from blocking the light of the LED pixel unit 230, the light sensing bearing substrate 212 is also transparent. In FIG. 4, although the light sensing bearing substrate 212 is located on one side, close to the light filtering layer 25, of the light sensing layer 24 and the light sensing bearing substrate 212 is arranged above the light sensing layer 24, in some other examples of this embodiment, the light sensing bearing substrate 212 may also be arranged below the light sensing layer 24. In FIG. 4, the display layer 23 and the light sensing layer 24 may further be located on one horizontal plane, the display layer 23 and the light sensing layer 24 may be even flush. In some other examples of this embodiment, the light sensing layer 24 and the display layer 23 may also be located on different horizontal planes, for example, the light sensing layer 24 may be higher than the display layer 23. For example, in one example, when the light sensing bearing substrate 212 is located between the light sensing unit 240 and the display layer 23, the light sensing layer 24 is necessarily higher than the display layer 23. In some other examples, even if the light sensing unit 240 is located between the light sensing bearing substrate 212 and the display bearing substrate 211, the light sensing layer 24 may be arranged higher than the display layer 23.

According to the foregoing description, the light filtering layer 25 includes light filtering units 250 corresponding to the light sensing units 240 in the light sensing layer 24 in position. In some examples of this embodiment, the light filtering layer 25 also includes a transparent adhesive layer 251 corresponding to the LED pixel units 230 in the display layer 23 in position, as shown in FIG. 2. In some examples, the display layer 23 and the light sensing layer 24 are located on one horizontal plane, and the LED pixel units 230 and the plurality of light sensing units 240 corresponding to one light filtering unit set (hereinafter, the plurality of light sensing units 240 corresponding to one light filtering unit set are referred to as a light sensing unit set) are alternately arranged on the bearing substrate 21. Correspondingly, the transparent adhesive layers 251 and the light filtering units 250 are alternately arranged on the light filtering configuration substrate 22. Certainly, in some other examples of this embodiment, a position, corresponding to the LED pixel units 230, in the light filtering layer 25 may be directly hollowed out and provided with no device.

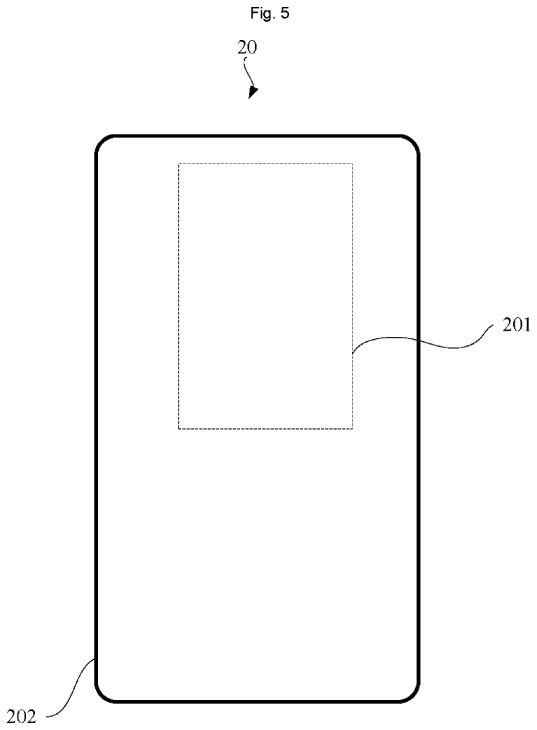

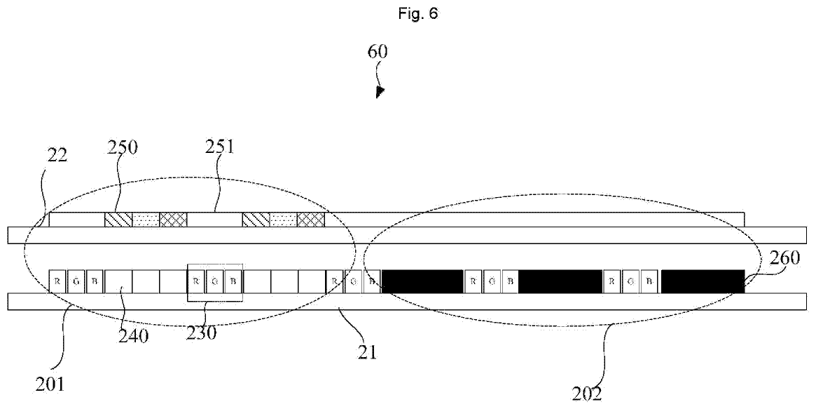

It is understandable that in some display screens, only a partial area may be used for image collection, in these examples, the light sensing layer 24, the light filtering layer 25 will be distributed in the partial area of the display screen merely, for example, with reference to FIG. 5, the display screen 20 includes a first area 201 and a second area 202. The first area 201 is a photographing area and the second area 202 is a non-photographing area, in this example, the light sensing units 240 and the light filtering units 250 are distributed in the first area 201 merely and not in the second area 202. In these examples, a light blocking unit may be arranged in a space between two adjacent LED pixel units 230 in the second area 202. For example, in further combination with a structural schematic diagram of a display screen 60 in FIG. 6, in the first area 201 of the display screen 60, the light sensing units 240 and LED pixel units 230 are both arranged on the bearing substrate 21, and the light sensing units 240 are arranged in a gap between the LED pixel units 230, and the light sensing unit set and the LED pixel units 230 are alternately arranged. In the second area 202, the LED pixel units 230 have a distribution density identical to a distribution density of the LED pixel units 230 in the first area 201, but the second area 202 does not include the light sensing units 240, and the light blocking unit 260 instead of the light sensing unit set is arranged in the gap between the LED pixel units 230. Moreover, in the first area 201, the light filtering units 250 have a distribution density identical to a distribution density of the light sensing units 240, but no light filtering unit 250 is arranged in the second area 202. In some examples of this embodiment, the transparent adhesive layer 251 may be arranged entirely in the second area 202 of the light filtering configuration substrate 22.

The light blocking unit 260 has a light blocking function and may be made of lightproof materials, for example, black glue, the light blocking unit 260 is arranged in a gap between adjacent LED pixel units 230, such that the situation that the display effect of the display screen is influenced due to mutual light crosstalk of the adjacent LED pixel units 230 may be avoided.

Undoubtedly, in some other examples of this embodiment, the light sensing units 240 and the light filtering units 250 may be uniformly distributed throughout all the areas, and the photographing areas are not distinguished from the non-photographing areas in these display screens.

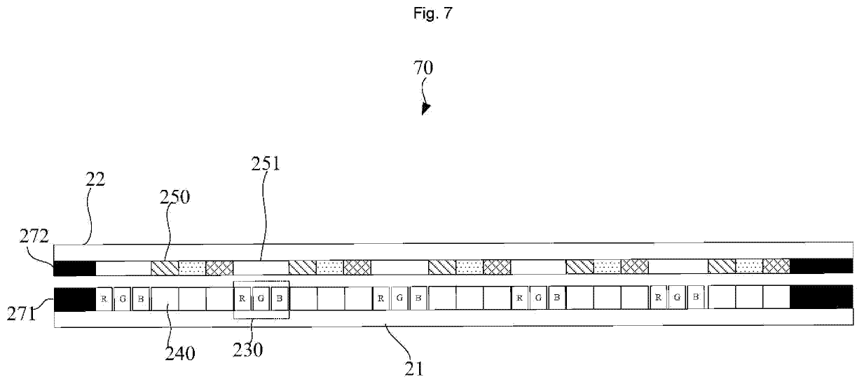

In some examples of this embodiment, with reference to FIG. 7, the display screen 70 includes a first retaining wall 271, and the first retaining wall 271 may be arranged on the bearing substrate 21, and may be located on the same side of the bearing substrate 21 as the LED pixel unit 230. The first retaining wall 271 is arranged along an edge of the bearing substrate 21, so as to enclose the display layer 23 and the light sensing layer 24. In this way, the situation that the display effect of the display layer 23 and the image collection effect of the light sensing layer 24 are influenced since external light enters the LED pixel units 230 and the light sensing units 240 from a side surface of the display screen 70 may be avoided.

It is understandable that under the condition that the bearing substrate 21 is divided into a display bearing substrate 211 and a light sensing bearing substrate 212, and the display layer 23 and the light sensing layer 24 are arranged on different substrates respectively, the first retaining wall 271 may be arranged on each of the display bearing substrate 211 and the light sensing bearing substrate 212; the first retaining wall 271 arranged on the display bearing substrate 211 is arranged along an edge of the display bearing substrate 211 and is used for enclosing the display layer 23 to prevent light from entering the LED pixel units 230 from the side surface of the display screen; and the first retaining wall 271 arranged on the light sensing bearing substrate 212 is arranged along an edge of the light sensing bearing substrate 212 and is used for enclosing the light sensing layer 24 to prevent light from entering the light sensing units 240 from the side surface of the display screen.

In some examples of this embodiment, with further reference to FIG. 7, a second retaining wall 272 is also arranged in the display screen 70, the second retaining wall 272 may be arranged along an edge of the light filtering configuration substrate 22 to enclose the light filtering layer 25, and when the light filtering layer 25 only includes light filtering units 250, the second retaining wall 272 encloses the light filtering units 250. When the light filtering layer 25 further includes a transparent adhesive layer 251, the second retaining wall 272 encloses the light filtering units 250 and the transparent adhesive layer 251 together, such that the situation that external light enters the light filtering units 250 from the side surface of the display screen 70 and then passes through the light filtering units 250 to be transmitted toward the light sensing units 240 to influence the image collection effect is avoided.

It is understandable that although both the first retaining wall 271 and the second retaining wall 272 are arranged in the display screen as shown in FIG. 7, it is also possible for only one of the two to be arranged in the display screens in other examples of this embodiment.

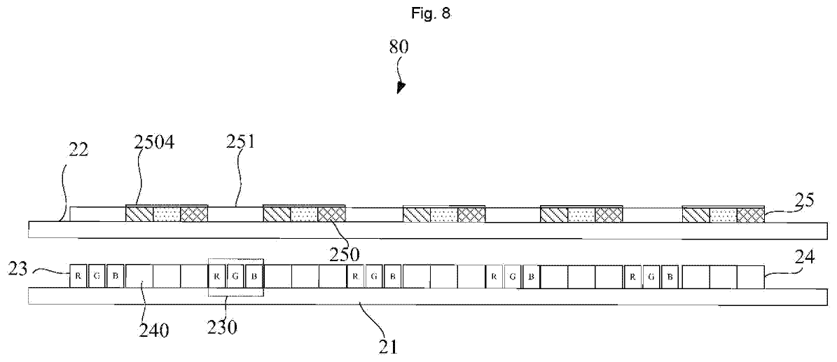

In some examples of this embodiment, in order to prevent light entering the light filtering layer 25 from escaping from the display screen, a one-way anti-reflection film 2504 is further arranged in the display screen. With reference to FIG. 8, the one-way anti-reflection film 2504 is arranged on one side, away from the light sensing units 240, of the light filtering units 250, that is, arranged on a light incident surface of the light filtering units 250. It is understandable that the one-way anti-reflection film 2504 should not cover the LED pixel units 230, such that when the one-way anti-reflection film 2504 is arranged, a complete one-way anti-reflection film layer may be firstly subjected to patterning processing so as to hollowed out a position corresponding to the LED pixel units 230, and then the patterned film layer is arranged on the light incident surface of the light filtering layer 25. In some other examples, the one-way anti-reflection film 2504 is arranged in the light filtering units 250 directly, for example, a light filtering unit set may be coated with one-way anti-reflection glue directly to form the one-way anti-reflection film 2504 in a process of preparing the light filtering units 250.

In some examples of this embodiment, the display screen further includes a display driving chip, the display driving chip is electrically connected to the display driving circuit and configured to receive a control signal from the main control chip and control the LED pixel units 230 via the display driving circuit to operate according to the control signal, thereby making the display layer 23 display an image.

In some other examples, the display screen includes a light sensing processing chip, and the light sensing processing chip is electrically connected to the light sensing units 240 via a light sensing input circuit. In this way, after the light sensing units 240 sense light and convert an optical signal into an electrical signal, the light sensing processing chip may receive a photoelectric conversion result of the light sensing units 240, and then the electrical signal transmitted by the light sensing units 240 is converted into a digital signal.

In some other examples, the display screen may simultaneously includes a display driving chip and a light sensing processing chip. Certainly, in some examples, the display screen itself may include no display driving chip or photosensitive processing chip, and when such a display screen is used in a terminal, a display driving chip needs to be additionally arranged in electrical connection to the display driving circuit, or a light sensing processing chip needs to be additionally arranged in electrical connection to the light sensing input circuit.

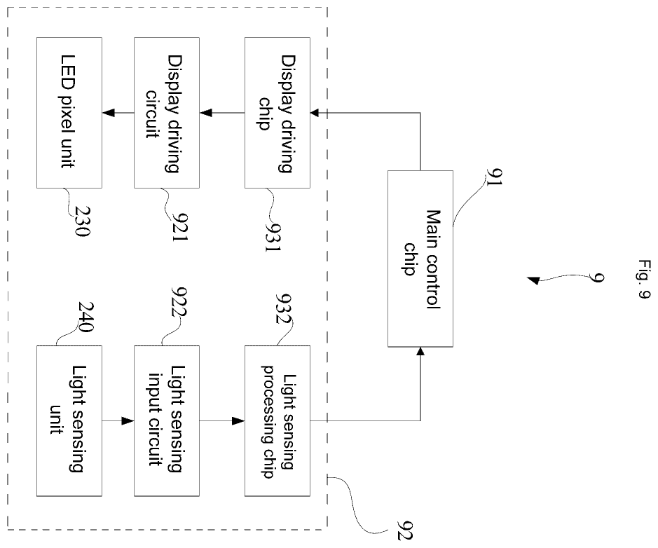

This embodiment also provides a terminal. The terminal may include a mobile terminal, for example, a mobile phone, a tablet computer, a laptop computer, a palmtop computer, a personal digital assistant (PDA), a portable media player (PMP), a navigation device, a wearable device, a smart band, a pedometer, etc., and a stationary terminal, for example, a digital TV, a desktop computer, etc. With reference to FIG. 9, the terminal 9 includes a main control chip 91 and a display screen 92, the display screen 92 may be a display screen provided in any one of the previous examples, and the main control chip 91 is connected to a display driving circuit 921 and a light sensing input circuit 922 in the display screen 92. It is understandable that the main control chip 91 may be connected to the display driving circuit 921 and the light sensing input circuit 922 via the display driving chip 931 and the light sensing processing chip 932 respectively. On one hand, the main control chip 91 may control the LED pixel units 230 via the display driving chip 931 and the display driving circuit 921 for display, and on the other hand, the main control chip may obtain an image collection result of the light sensing units 240 via the light sensing input circuit 922 and the light sensing processing chip 932.

It is understandable that although the display screen 92 in FIG. 9 includes the display driving chip 931 and the light sensing processing chip 932, for display screens provided in some other examples, the display screen 92 itself may include no display driving chip 931 and/or light sensing processing chip 932.

It is understandable that the terminal 9 may further include a radio frequency (RF) unit, a WiFi module, an audio output unit, a sensor, a user input unit, an interface unit, a memory, and other components except for the main control chip 91 and the display screen 92.

The display screen provided in this embodiment not only has a display function, but also integrates an image collection function, such that a terminal using the display screen does not need to be additionally provided with a camera module, cost of the terminal may be reduced, a thickness and size of the terminal may be reduced, portability of the terminal is improved, and product competitiveness of the terminal is enhanced.

### Another Optional Embodiment of the Present Application

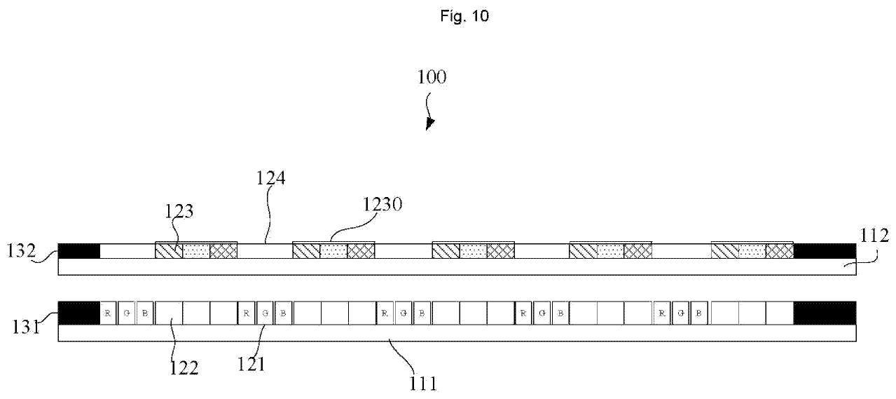

In order to make the structural details and advantages of the aforementioned display screen and terminal clearer to those skilled in the art, this embodiment will continue to describe the display screen in conjunction with an example. With reference to FIG. 10, the display screen 100 includes a bearing substrate 111 and a light filtering configuration substrate 112, which are arranged opposite each other. Since the bearing substrate 111 is lower than the light filtering configuration substrate 112, the bearing substrate 111 and the light filtering configuration substrate 112 may also be referred to as a “lower substrate” and an “upper substrate” respectively. In this embodiment, the bearing substrate 111 and the light filtering configuration substrate 112 each consist of one substrate, and both may be transparent substrates. For example, in some examples of this embodiment, the bearing substrate 111 and the light filtering configuration substrate 112 are both glass substrates, and in other examples of this embodiment, the bearing substrate 111 and the light filtering configuration substrate 112 may also be sapphire substrates.

A plurality of LED pixel units 121 and a plurality of light sensing units 122 are arranged on the bearing substrate 111, a plurality of light filtering units 123 and a plurality of transparent layers 124 located on one horizontal plane are arranged on the light filtering configuration substrate 112, the light sensing units 122 are arranged in gaps between the LED pixel units 121, and the number of the light filtering units 123 and an area of the light filtering units on the horizontal plane are identical to that of the light sensing units 122; moreover, positions of the light filtering units 123 are opposite positions of the light sensing units 122; and an area of the transparent layers 124 on the horizontal plane is identical to that of the LED pixel units 121, and the transparent layers and the LED pixel units are opposite in position.

In this embodiment, the LED pixel units 121 at least include a red LED chip, a green LED chip, and a blue LED chip. The LED chips in this embodiment include, but are not limited to, a Micro-LED, a mini-LED, an organic light-emitting diode (OLED), etc.

The light sensing units 122 may include, but is not limited to, at least one of a charge coupled device (CCD) and a complementary metal oxide conductor (CMOS) device, which may convert an optical signal transmitted from the light filtering units 123 into an electrical signal.

The light filtering units 123 include a one-way anti-reflection film 1230 arranged on a light incident surface of the light filtering units 123, and the one-way anti-reflection film 1230 may prevent light, close to the side of the light sensing units 122, of the light filtering units 123 from escaping to an opposite side. After the one-way anti-reflection film 1230 is arranged, the light filtering units 123 does not display a color to the outside.

In this embodiment, the display screen 100 further includes a first retaining wall 131 and a second retaining wall 132, the first retaining wall 131 is arranged on the bearing substrate 111 and located on the same side as the LED pixel units 121 and the light sensing units 122, and the first retaining wall 131 is arranged along an edge of the bearing substrate 111 and attached to the LED pixel units 121 and/or the light sensing units 122 located at an outermost edge. In addition, a height of the first retaining wall 131 is basically consistent with that of the LED pixel units 121 and that of the light sensing units 122 or slightly larger than that of the LED pixel units 121 and that of the light sensing units 122, such that it may be guaranteed that no light enters the LED pixel units 121 or the light sensing units 122 from a side surface of the display screen 100, so as to guarantee a display effect and an image collection effect of the display screen 100.

The second retaining wall 132 is arranged on the light filtering configuration substrate 112 and located on the same side as the transparent layer 124 and the light filtering units 123, and the second retaining wall 132 is arranged along an edge of the light filtering configuration substrate 112 and attached to the transparent layer 124 and/or the light filtering units 123 located on an outermost edge. In addition, a height of the second retaining wall 132 is basically consistent with that of the light filtering units 123 and the transparent layer 124 or is slightly larger than that of the light filtering units 123 and the transparent layer 124, such that it may be guaranteed that no light enters the transparent layer 124 or the light filtering units 123 from the side surface of the display screen 100, so as to avoid an influence on a display effect of the LED pixel units 121 and interference in a photographing effect of the light sensing units 122.

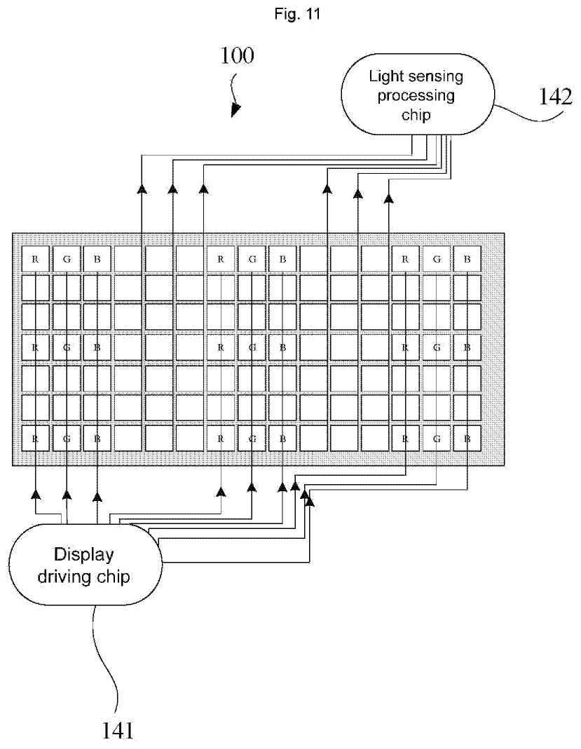

With reference to FIG. 11, in this embodiment, the display screen 100 also includes a display driving chip 141 and a light sensing processing chip 142, where the display driving chip 141 is electrically connected to the LED pixel units 121 via a display driving circuit, and the light sensing processing chip 142 is electrically connected to the light sensing units 122 via a light sensing input circuit. In this embodiment, the display driving circuit may be arranged in a gap between adjacent LED pixel units 121 on the bearing substrate 111, and the light sensing input circuit may be arranged in a gap between adjacent light sensing units 122 on the bearing substrate 111. Notably, in FIG. 11, circuits for driving LED chips by the display driving chip 141 are not shown all, the light sensing input circuits between light sensing units 122 and the light sensing processing chip 142 are not shown all, and only connections between some of the LED chips and the display driving chip 141 and some of the light sensing units 122 and the light sensing processing chip 142 are illustrated.

In some examples, when the display screen 100 is used in a terminal (for example, a mobile phone, a tablet computer, and a wearable device) that includes a main control chip, the display driving chip 141 and the light sensing processing chip 142 may cooperate under the control of the main control chip. Alternatively, the display driving chip 141 and the light sensing processing chip 142 may be arranged on a chip on flex, or, chip on film (COF), and may be located on different COFs.

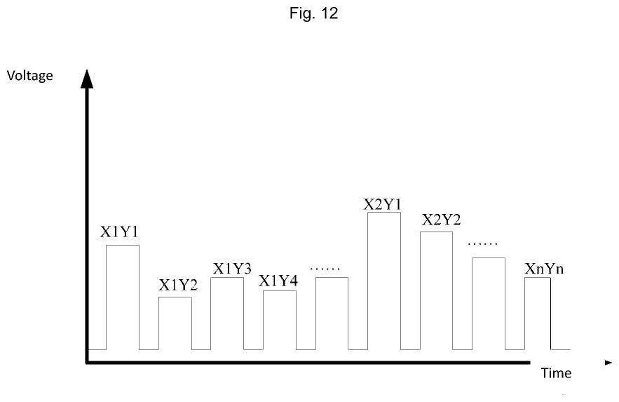

It is understandable that in a finished display screen, a position of each light sensing unit 122 on the display screen and the light filtering unit 123 corresponding to the light sensing unit 122 are determined, such that after the light sensing processing chip 142 obtains a voltage amplitude of an electrical signal transmitted by a light sensing unit 122, brightness of a color corresponding to the light sensing unit 122 may be determined, and the light sensing processing chip 142 may determine a pixel value of an image pixel point by integrating the colors and the brightness corresponding to the plurality of light filtering units 123. In some examples of this embodiment, the light sensing processing chip 142 may obtain the voltage values of the light sensing units 122 one by one from left to right and from top to bottom according to arrangement positions of the light sensing units 122 on the display screen 100. For example, with reference to FIG. 12, a schematic diagram illustrating obtaining of a voltage value of light sensing units 122 by a light sensing processing chip 142 is shown. XnYn represents light sensing units having coordinates (Xn, Yn), the abscissa represents a time at which the voltage value of the light sensing units 122 is obtained, and the ordinate represents the voltage value of the corresponding light sensing units 122. In some other examples, the light sensing processing chip 142 may divide the display screen 100 into a plurality of areas, and then obtain the voltage values of the light sensing units 122 in a certain order in each of the areas. The voltage values corresponding to the light sensing units 122 in different areas may be obtained simultaneously.

This embodiment further provides a terminal. The terminal includes a main control chip and the display screen 100, the display screen 100 is in communication connection with the main control chip, and the main control chip may be a processor of the terminal.

The display screen provided in this embodiment uses a light sensing principle of a CCD camera, so as to implement image collection, integrate a display function and a photographing function, and reduce a thickness of the terminal, and the terminal cost is also saved since a terminal equipment manufacturer does not need to purchase a camera module additionally.

It should be understandable that the application of the present application is not to be limited to the above examples and that modifications or variations may be made for those of ordinary skill in the art in light of the above description, all of which are intended to fall within the scope of protection of the appended claims of the present application.

1. A display screen, comprising:
a bearing substrate;
a transparent light filtering configuration substrate;
a display layer comprising a plurality of light-emitting diode (LED) pixel units, the LED pixel units being configured to convert an electrical signal into an optical signal;
a light sensing layer comprising a plurality of light sensing units, the light sensing units being configured to convert an optical signal into an electrical signal; and
a light filtering layer comprising a plurality of light filtering units;
wherein the light filtering units are arranged on the light filtering configuration substrate, and the LED pixel units and the light sensing units are all arranged on the bearing substrate and electrically connected to a display driving circuit on the bearing substrate and a light sensing input circuit on the bearing substrate respectively; light incident surfaces of the light sensing units and light emergent surfaces of the LED pixel units face a same direction, and the light incident surfaces of the light sensing units face the light filtering units; and the light sensing units are located in spaces between adjacent LED pixel units and correspond to the light filtering units in position.

2. The display screen according to claim 1, further comprising a display driving chip and a light sensing processing chip, wherein the display driving chip is configured to receive a control signal from a main control chip and control, via the display driving circuit according to the control signal, the LED pixel unit to work; and the light sensing processing chip is configured to receive, via the light sensing input circuit, an electrical signal converted by the light sensing units and convert the electrical signal into image data.

3. The display screen according to claim 1, further comprising a one-way anti-reflection film arranged on one side, away from the light sensing units, of the light filtering units.

4. The display screen according to claim 1, wherein the display layer and the light sensing layer are located on a same horizontal plane.

5. The display screen according to claim 4, further comprising a first retaining wall arranged along an edge of the bearing substrate and enclosing the display layer and the light sensing layer.

6. The display screen according to claim 1, wherein the light filtering layer further comprises a transparent adhesive layer which is opposite to the LED pixel unit in the display layer in position.

7. The display screen according to claim 6, further comprising a second retaining wall arranged along an edge of the light filtering configuration substrate and enclosing the light filtering layer.

8. The display screen according to claim 1, comprising a first area and a second area, wherein the light sensing units and the light filtering units are distributed in the first area merely; and in the second area, a light blocking unit is arranged in a space between adjacent LED pixel units.

9. The display screen according to claim 1, wherein the light sensing units are uniformly distributed in all areas of the display screen.

10. A terminal, comprising a main control chip and the display screen according to claim 1, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.

11. The display screen according to claim 1, wherein the light filtering configuration substrate comprises:
a glass substrate and/or a sapphire substrate.

12. The display screen according to claim 1, wherein the light filtering configuration substrate is arranged between the light filtering layer and the light sensing layer, or the light filtering configuration substrate is arranged on one side, away from the light sensing layer, of the light filtering layer.

13. The display screen according to claim 5, wherein the bearing substrate comprises a display bearing substrate and a light sensing bearing substrate;
the display layer is arranged on the display bearing substrate and the light sensing layer is arranged on the light sensing bearing substrate; or,
the display layer is arranged on the light sensing bearing substrate and the light sensing layer is arranged on the display bearing substrate.

14. The display screen according to claim 13, wherein the first retaining wall is arranged on each of the display bearing substrate and the light sensing bearing substrate,
the first retaining wall arranged on the display bearing substrate is arranged along an edge of the display bearing substrate and enclosing the display layer to prevent light from entering the LED pixel units from a side surface of the display screen; and
the first retaining wall arranged on the light sensing bearing substrate is arranged along an edge of the light sensing bearing substrate and enclosing the light sensing layer to prevent light from entering the light sensing units from the side surface of the display screen.

15. The display screen according to claim 1, further comprising a one-way anti-reflection film arranged in the light filtering units.

16. A terminal, comprising a main control chip and the display screen according to claim 2, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.

17. A terminal, comprising a main control chip and the display screen according to claim 3, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.

18. A terminal, comprising a main control chip and the display screen according to claim 4, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.

19. A terminal, comprising a main control chip and the display screen according to claim 5, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.

20. A terminal, comprising a main control chip and the display screen according to claim 6, wherein the main control chip is configured to be in communication connection with the LED pixel units via a display driving chip and a display driving circuit so as to control the LED pixel units for display, and the main control chip is configured to be in communication connection with the light sensing units via a light sensing processing chip and a light sensing input circuit so as to obtain image collection results of the light sensing units.
